(19) United States
(12) Patent Application Publication
(10) Pub. No.: US 2010/0226708 A1
(43) Pub. Date: Sep. 9, 2010

(54) NOTEBOOK

(76) Inventor: PERRY CHARLES BOGAL, Scottsdale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/396,800

(22) Filed: Mar. 3, 2009

(51) Int. Cl. B42F 3/00

(52) U.S. Cl. 402/70

(57) ABSTRACT

A notebook consists of a notebook of or for sheet material, such as paper, notes, preprinted sheets or forms, and the like. A whiteboard is formed in a base, and an engagement element is formed in the base. A detachably engagable complemental engagement element is formed in the notebook to detachably secure the base, and the whiteboard carried by the base, to the notebook leaving the whiteboard available for use in accepting writing from a whiteboard marker.

### FIELD OF THE INVENTION

The present invention relates to notebooks.

### BACKGROUND OF THE INVENTION

A notebook is a book of or for paper, notes, preprinted sheets or forms, and the like. Notebooks normally include a notebook cover formed with a binder that binds the paper, notes, preprinted sheets or forms, or the like, to the notebook cover. Notebooks are common and are put to use for a wide range of uses. Although notebooks have been in use in various and wide-ranging forms since the late 18003 s, innovations continue to be made in notebooks, particularly with respect to improved binders and folder materials and configurations. However, the overall function of notebooks in retaining sheet material for various purposes remains essentially the same, and it would be highly desirable to make meaningful improvements to enhance the overall usefulness of notebooks.

### SUMMARY OF THE INVENTION

According to the principle of the invention, disclosed is a notebook of or for sheet material, a whiteboard formed in a base, an engagement element formed in the base, and a detachably engagable complemental engagement element formed in the notebook to detachably secure the base, and the whiteboard carried by the base, to the notebook leaving the whiteboard available for use in accepting writing from a whiteboard marker. In a preferred embodiment, the engagement element is one of magnet material and magnet-attracting material, and the complemental engagement element is the other of the magnet material and the magnet-attracting material. A whiteboard cover is mounted to the base for movement between a first position away from the whiteboard and a second position overlying and protecting the whiteboard and any writing applied to the whiteboard. The whiteboard cover consists of a sheet of thin, flexible material, which is preferably transparent to allow writing applied to the whiteboard to be seen therethrough.

According to the principle of the invention, a notebook includes a binder, to receive and retain sheets of paper, formed in a notebook cover, a sheet of substantially rigid material having opposed upper and lower faces, the upper face of the sheet of substantially rigid material formed with a whiteboard, the lower face of the sheet of substantially rigid material formed with an engagement element, and the notebook cover formed with a detachably engagable complemental engagement element. In a preferred embodiment, the engagement element is one of magnet material and magnet-attracting material, and the complemental engagement element is the other of the magnet material and the magnet-attracting material. A whiteboard cover is mounted to the sheet of substantially rigid material for movement between a first position away from the whiteboard and a second position overlying and protecting the whiteboard. The whiteboard cover is a sheet of thin, flexible material, which is preferably transparent to permit any writing applied to the whiteboard to be seen therethrough in the second position of the whiteboard cover overlying and protecting the whiteboard. At least one whiteboard marker is removably held by the notebook cover, and at least one whiteboard eraser is removably held by the notebook cover.

According to the principle of the invention, a notebook includes a spine formed with a binder to receive and retain sheets of paper. The spine is coupled between opposed first and second covers. The first and second covers are substantially coextensive, and are together movable at the spine between open and closed positions with respect to the binder formed in the spine. A sheet of substantially rigid material is provided, which has opposed upper and lower faces. The upper face of the sheet of substantially rigid material is formed with a whiteboard, the lower face of the sheet of substantially rigid material is formed with an engagement element, and the first cover is formed with a detachably engagable complemental engagement element to detachably engage the engagement element for detachably securing the sheet of substantially rigid material in place to the first cover leaving the whiteboard available for use in accepting writing from a whiteboard marker. In a preferred embodiment, the engagement element is one of magnet material and magnet-attracting material, and the complemental engagement element is the other of the magnet material and the magnet-attracting material. Further to the present embodiment is a whiteboard cover mounted to the sheet of substantially rigid material for movement between a first position away from the whiteboard and a second position overlying and protecting the whiteboard to prevent writing applied to the whiteboard from smearing or from becoming inadvertently erased. The whiteboard cover is preferably a sheet of thin, flexible material, such as thin, flexible plastic. The sheet is thin, flexible material is preferably transparent to permit any writing applied to the whiteboard to be seen therethrough in the second position of the whiteboard cover overlying and protecting the whiteboard. The spine and the first and second covers together form a notebook cover of the notebook. At least one whiteboard marker is removably held by the notebook cover, and at least one whiteboard eraser is removably held by the notebook cover.

According to the principle of the invention, a notebook includes a spine formed with a binder to receive and retain sheets of paper, and which is coupled between opposed first and second covers. The first cover has a first inner face, and the second cover has a second inner face. A sheet of substantially rigid material has opposed upper and lower faces. The upper face of the sheet of substantially rigid material is formed with a whiteboard, the lower face of the sheet of substantially rigid material is formed with an engagement element, and the first inner face of the first cover is formed with a detachably engagable complemental engagement element. The engagement element is detachably engaged to the complemental engagement element detachably engaging the sheet of substantially rigid material to the first inner face of the front cover leaving the whiteboard available to receive writing thereon. The first and second covers are together movable at the spine between an open position exposing the binder, the whiteboard, and the second inner face of the second cover, and a closed position bringing the first inner face of the first cover in juxtaposition with respect to the second inner face of the second cover to substantially enclose the whiteboard and the binder between the first and second inner faces of the first and second covers, respectively. In a preferred embodiment, the engagement element is one of magnet material and magnet-attracting material, and the complemental engagement element is the other of the magnet material and the magnet-attracting material. A whiteboard cover is mounted to the sheet of substantially rigid material for movement between a first position away from the whiteboard and a second position across the whiteboard overlying and protecting the whiteboard to prevent writing applied to the whiteboard from smearing or from becoming inadvertently erased. The whiteboard cover is preferably a sheet of thin, flexible material, such as thin, flexible plastic. The sheet is thin, flexible material is preferably transparent to permit any writing applied to the whiteboard to be seen therethrough in the second position of the whiteboard cover overlying and protecting the whiteboard. The spine and the first and second covers together form a notebook cover of the notebook. At least one whiteboard marker is removably held by the notebook cover, and at least one whiteboard eraser is removably held by the notebook cover.

According to the principle of the invention, provided is a notebook a notebook of or for sheet material, and a whiteboard formed in the notebook. A whiteboard cover is mounted to notebook for movement between a first position away from the whiteboard and a second position overlying and protecting the whiteboard. The whiteboard cover is a sheet of thin, flexible material, which is transparent. In one embodiment, the whiteboard and the whiteboard cover are affixed to an inner face of the notebook, and in another embodiment the whiteboard and the whiteboard cover are affixed to an outer face of the notebook.

### BRIEF DESCRIPTION OF THE DRAWINGS

Referring to the drawings:

FIG. 1 is a perspective view of a notebook constructed and arranged in accordance with the principle of the invention and being shown as it would appear in an open position illustrating a whiteboard formed in a base attached to the inner face of a front cover of a notebook cover of the notebook;

FIG. 2 is a perspective view of the notebook of FIG. 1 being shown as it would appear in a closed position;

FIG. 3 is a fragmented perspective view of the notebook of FIG. 1 illustrating with the base formed with the whiteboard being shown detached from the inner face of the front cover of the notebook cover of the notebook;

FIG. 4 is a fragmented end elevation view of the notebook of FIG. 1 illustrating with the base formed with the whiteboard being shown detached from the inner face of the front cover of the notebook cover of the notebook;

FIG. 5 is a generalized perspective view of the base formed with the whiteboard of the notebook of FIG. 1 being shown positioned in preparation for attachment to a refrigerator;

FIG. 6 is a generalized, partially exploded perspective view of the base formed with the whiteboard of the notebook of FIG. 1;

FIG. 7 is a generalized perspective view of an alternate embodiment of a base formed with a whiteboard for use in conjunction with a notebook constructed and arranged in accordance with the principle of the invention;

FIG. 8 is a perspective view of an alternate embodiment of a notebook constructed and arranged in accordance with the principle of the invention and being shown as it would appear in an open position illustrating a whiteboard formed in an inner face of a front cover of a notebook cover of the notebook;

FIG. 9 is a perspective view of the notebook of FIG. 8 being shown as it would appear in a closed position; and

FIG. 10 is a fragmented, vertical sectional view of the front cover of the notebook of FIGS. 8 and 9.

### DETAILED DESCRIPTION OF PREFERRED EMBODIMENTS

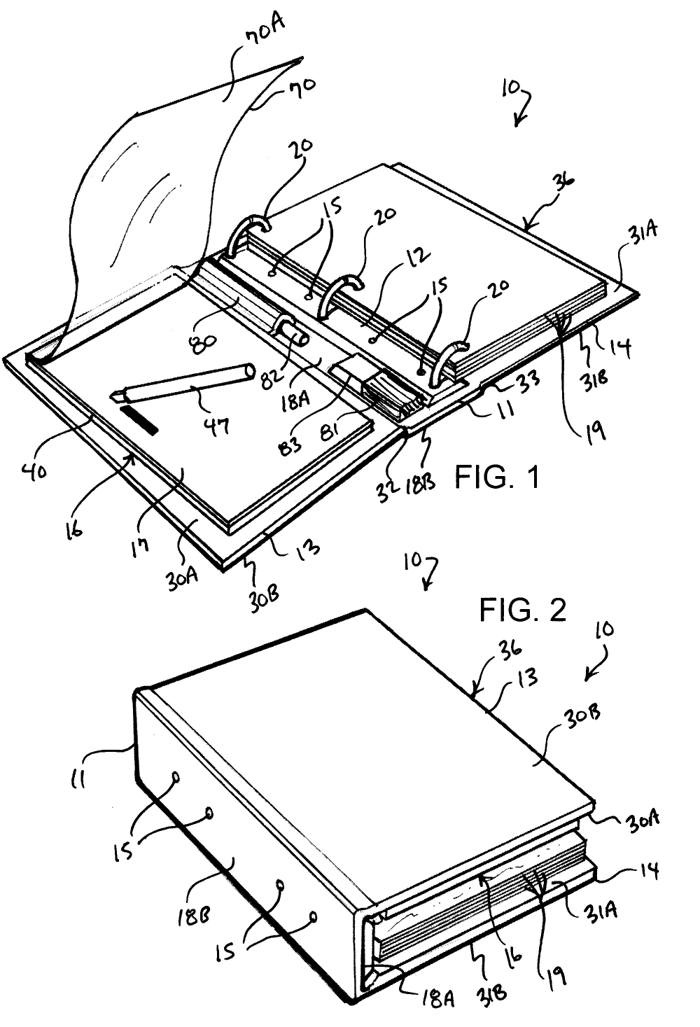

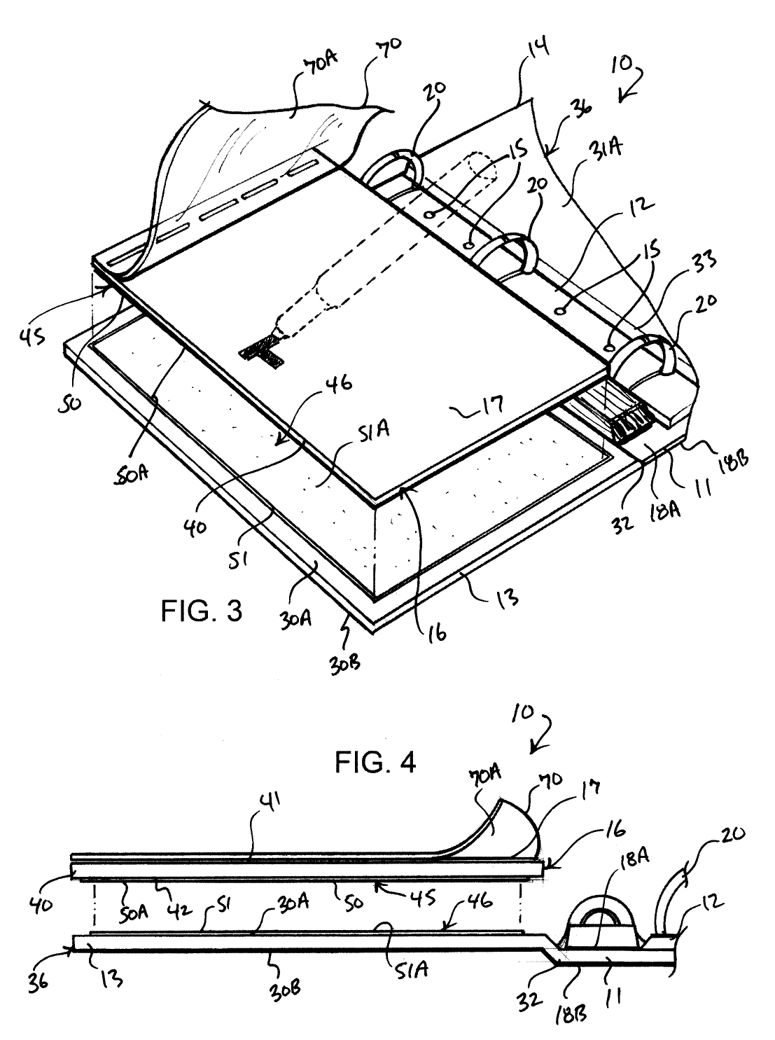

Turning now to the drawings, in which like reference characters indicate corresponding elements throughout the several views, attention is first directed to FIG. 1 in which there is seen a notebook 10 constructed and arranged in accordance with the principle of the invention. Notebook 10 is of or for sheet material, such as paper, notes, preprinted sheets or forms, and the like. A whiteboard 17 is formed in a base 16. An engagement element 45 denoted in FIGS. 3, 4, and 6, is formed in base 16. A detachably engagable complemental engagement element 46 denoted in FIGS. 3 and 4 is formed in notebook 10 to detachably secure base 16, and thus whiteboard 17 carried by base 16, to notebook 10 leaving whiteboard 17 available for use in accepting writing from a whiteboard marker.

More specific details of notebook 10 will now be discussed. In this specific embodiment, notebook 10 has a notebook cover 36, which is formed with complemental engagement element 46 denoted in FIGS. 3 and 4, that in use detachably engages engagement element 45 carried by base 16, as illustrated in FIG. 1, to detachably secure base 16, and whiteboard 17 carried by base 16, to notebook cover 36 of notebook 10 leaving whiteboard 17 available for use in accepting writing from a whiteboard marker denoted in FIG. 1 at 47.

Notebook 10 is fashioned with a binder 12. Binder 12 is to receive and retain sheet material, such as paper, notes, preprinted sheets or forms, and the like. Binder 12 is formed in notebook cover 36. Notebook cover 36 consists of a spine 11 coupled between opposed covers 13 and 14. Spine 11 coupled between covers 13 and 14 is formed with binder 12. Spine 11 has opposed inner and outer faces 18A and 18B. Binder 12 is positioned on an inner face 18A of spine 11, and is secured to spine 11 with fasteners 15, such as rivets, pins, or the like.

Binder 12 receives and retains sheets 19 of paper. In the present embodiment, binder 12 is a conventional and well-known clamp or ring binder incorporating generally circular clamps 20 that may be opened and closed, and which are run through punched holes in sheets 19 of paper thereby holding and retaining sheets 19 of paper. Clamps 20 are preferably spring-loaded as with conventional ring binders. Sheets 19 of paper are each a standard 8½″×11″ in size, and binder 12 is commensurately sized. Sheets 19 of paper may be provided in other sizes and binder 12 sized accordingly without departing from the invention. In the present embodiment, binder 12 incorporates three clamps 20, and less or more can be used without departing from the invention.

Covers 13 and 14 are substantially coextensive, and together with spine 11 form notebook cover 36 of notebook 10. Cover 13 is broad and flat and has opposed inner and outer faces 30A and 30B, and cover 14 is broad and flat and has opposed inner and outer faces 31A and 31B. Cover 13 is considered the front cover of notebook cover 36, and cover 14 is considered the back cover of notebook cover 36. Covers 13 and 14 are secured to either side of spine 11, and are together movable at spine 11 between an open position illustrated in FIG. 1 defining an open position of notebook cover 36 and notebook 10, and a closed position illustrated in FIG. 2 illustrating a closed position of notebook cover 36 and notebook 10. A hinge 32 is formed between cover 13 and one side of spine 11, and a hinge 33 is formed between cover 14 and the opposing side of spine 11. Hinges 32 and 33 are conventional living hinges in the present embodiment, and provide a pivotal coupling or attachment between covers 13 and 14, respectively, and spine 11, and permit pivotal movement of covers 13 and 14 at spine 11 between the open and closed positions of covers 13 and 14 to define the open and closed positions of notebook cover 36 and notebook 10. Inner faces 30A and 31A of covers 13 and 14, and inner face 18A of spine 11 together form the inner side of notebook cover 36, which opposes the outer side of notebook cover 36 formed by outer faces 30B and 31B of covers 13 and 14 and outer face 18B of spine 11.

In the open position of covers 13 and 14 illustrated in FIG. 1 defining the open position of notebook 10, covers 13 and 14 extend outwardly away from either side of binder 12 and are open with respect to binder 12 and sheets 19 of paper held by binder 12 thereby opening the inner side of notebook cover 36 exposing binder 12 and sheets 19 of paper held by binder 12. In a further and more specific aspect, in the open position of covers 13 and 14 illustrated in FIG. 1 defining the open position of notebook 10, inner faces 30A and 31A of covers 13 and 14 extend outwardly away from either side of binder 12, inner faces 30A and 31A of covers 13 and 14 are open and exposed, and inner faces 30A and 31A of covers 13 and 14 are open with respect to binder 12 and sheets 19 of paper held by binder 12 thereby exposing binder 12 and sheets 19 of paper held by binder 12. In the open position of covers 13 and 14 as illustrated in FIG. 1, sheets 19 of paper are shown stacked atop inner face 31A of cover 14 as a matter of example.

In the closed position of covers 13 and 14 as illustrated in FIG. 2 defining the closed position of notebook 10, cover 13 is juxtaposed with respect to cover 14 such that cover 13 opposes or otherwise confronts cover 14 closing the inner side of notebook cover 36, cover 13 is substantially parallel with respect to cover 14, and binder 12 and sheets 19 of paper held by binder 12 are substantially enclosed or otherwise contained between covers 13 and 14. In a further and more specific aspect, in the closed position of covers 13 and 14 as illustrated in FIG. 2 defining the closed position of notebook inner face 30A of cover 13 is juxtaposed with respect to inner face 31A of cover 14 such that inner face 30A of cover 13 opposes or otherwise confronts inner face 31A of cover 14, inner face 30A of cover 13 is substantially parallel with respect to inner face 31A of cover 14, and binder 12 and sheets 19 of paper held by binder 12 are substantially enclosed or otherwise contained between inner faces 30A and 31A covers 13 and 14.

The combination of binder 12 and notebook cover 36 of notebook 10 is a common and readily available notebook arrangement, and may be formed in many different styles and in many different materials, further details of which will readily occur to the skilled artisan. Binder 12 is illustrative of a conventional clamp or ring binder. In place of binder 12, other binder forms may be used, such as spiral binders, tie binders, prong binders, etc.

Referencing FIGS. 1, 3, 4, and 6, base 16 is a sheet 40 of substantially rigid material such as plastic, fiber board, wood, metal, or the like. Sheet 40 is flat and robust, has opposed upper and lower faces 41 and 42 denoted in FIG. 4, and is smaller in size with respect to each of covers 13 and 14. Upper face 41 of sheet 40 is formed with whiteboard 17, and lower face 42 of sheet 40 is formed with engagement element 45.

Whiteboard 17 is a glossy, sheet-like substrate, most commonly colored white, where non-permanent markings from non-permanent markers, e.g., whiteboard markers, can be made. Whiteboard 17 operates analogously to a chalkboard, in that it allows markings from non-permanent markers to temporarily adhere to the surface of whiteboard 17. Whiteboard 17 is integrally formed on upper face 41. In other embodiments whiteboard 17 is glued onto upper face 41 of sheet 40, or laminated onto upper face 41 of sheet 40.

Referencing FIGS. 3 and 4, notebook cover 36 is formed with detachably engagable complemental engagement element 46 to detachably engage engagement element 45 to detachably secure sheet 40, and thus whiteboard 17, to notebook cover 36, and thus to notebook 10, leaving whiteboard 17 exposed as illustrated in FIG. 1 in preparation for use in accepting writing from a whiteboard marker 47. In the present and preferred embodiment, inner face 30A of cover 13 is formed with detachably engagable complemental engagement element 46 illustrated in FIGS. 3 and 4 to detachably engage engagement element 45 for detachably securing sheet 40 in place to inner face 30A of cover 13 leaving whiteboard 17 exposed as illustrated in FIG. 1 in preparation for use in accepting writing from a whiteboard marker 47. With sheet 40 secured in place with respect to notebook cover 36 of notebook 10 as illustrated, whiteboard 17 is exposed and available to be used without obstruction, in accordance with the principle of the invention. Because engagement element 46 and complemental engagement element 46 form a detachably engagement between whiteboard 17 and notebook cover 36, engagement element 45 may be easily detached from complemental engagement element 46 to detach base 16 from notebook cover 36 when desired to allow use of whiteboard 17 in its normal and customary manner apart from notebook cover 36, in accordance with the principle of the invention.

To engage engagement element 45 carried by sheet 40 to complemental engagement element carried by cover 13 to detachably engage base 16, and whiteboard 17 carried by base 16, to notebook 10, sheet 40 is taken up, such as by hand, and oriented to direct and align engagement element 45 formed in lower face 42 toward complemental engagement element 46 formed in inner face 30A of cover 13, and sheet 40 is then applied directing engagement element 45 into detachably engagement with complemental engagement element 46 thereby detachably securing sheet 40, and whiteboard 17 carried thereby, to inner face 30A of cover 13. One need only reverse this operation to detach whiteboard 17 carried by sheet 40 forming base 16 from notebook cover 36 of notebook 10. Sheet 40 is smaller in overall size with respect to cover 13, and fits within the outer perimeter of cover 13 as depicted in FIG. 1.

With engagement element 45 detachably engaged to complemental engagement element 46 detachably securing sheet 40 in place to inner face 30A of cover 13 thereby detachably securing whiteboard 17 with respect to inner face 30A of cover 13 of notebook cover 36 leaving whiteboard 17 exposed and thereby available for use in accepting writing from whiteboard marker 47, in the open position of covers 13 and 14 illustrated in FIG. 1 defining the open position of notebook 10 covers 13 and 14 extend outwardly away from either side of binder 12 and are open with respect to whiteboard 17, binder 12 and sheets 19 of paper held by binder 12 thereby opening the inner side of notebook cover 36 exposing whiteboard 17, binder 12 and sheets 19 of paper held by binder 12. In a further and more specific aspect, in the open position of covers 13 and 14 illustrated in FIG. 1 defining the open position of notebook 10, inner faces 30A and 31A of covers 13 and 14 extend outwardly away from either side of binder 12, inner faces 30A and 31A of covers 13 and 14 are open and exposed, and inner faces 30A and 31A of covers 13 and 14 are open with respect to whiteboard 17, binder 12 and sheets 19 of paper held by binder 12 thereby exposing whiteboard 17, binder 12 and sheets 19 of paper held by binder 12. In the closed position of covers 13 and 14 as illustrated in FIG. 2 defining the closed position of notebook 10, cover 13 is juxtaposed with respect to cover 14 such that cover 13 opposes or otherwise confronts cover 14 closing the inner side of notebook cover 36, cover 13 is substantially parallel with respect to cover 14, and whiteboard 17, binder 12 and sheets 19 of paper held by binder 12 are substantially enclosed or otherwise contained between covers 13 and 14. In a further and more specific aspect, in the closed position of covers 13 and 14 as illustrated in FIG. 2 defining the closed position of notebook 10, inner face 30A of cover 13 is juxtaposed with respect to inner face 31A of cover 14 such that inner face 30A of cover 13 opposes or otherwise confronts inner face 31A of cover 14, inner face 30A of cover 13 is substantially parallel with respect to inner face 31A of cover 14, and whiteboard 17, binder 12 and sheets 19 of paper held by binder 12 are substantially enclosed or otherwise contained between inner faces 30A and 31A of covers 13 and 14 of notebook 10.

In the preferred embodiment, engagement element 45 is magnet material 50 as denoted in FIGS. 3, 4, and 6, and complemental engagement element is magnet-attracting material 51 as denoted in FIGS. 3 and 4, such as ferrous metal. In this particular embodiment, magnet material 50 is provided in the form of a magnet sheet 50A, which is applied to lower face 42 of sheet 40 and secured to lower face 42 of sheet, such as by gluing, lamination, or the like. In the present embodiment, magnet sheet 50A forming magnet material 50 is substantially coextensive with respect to lower face 42 of sheet 40. Magnet-attracting material 51 is provided in the form of a magnet-attracting sheet 51A of ferrous metal, which is applied to inner face 30A of cover 13 and secured to inner face 30A of cover 13, such as by gluing, lamination, rivets or other fasteners, or the like. In the present embodiment, magnet-attracting sheet 51A of ferrous material forming magnet-attracting material 51 is substantially coextensive with respect to magnet sheet 50A.

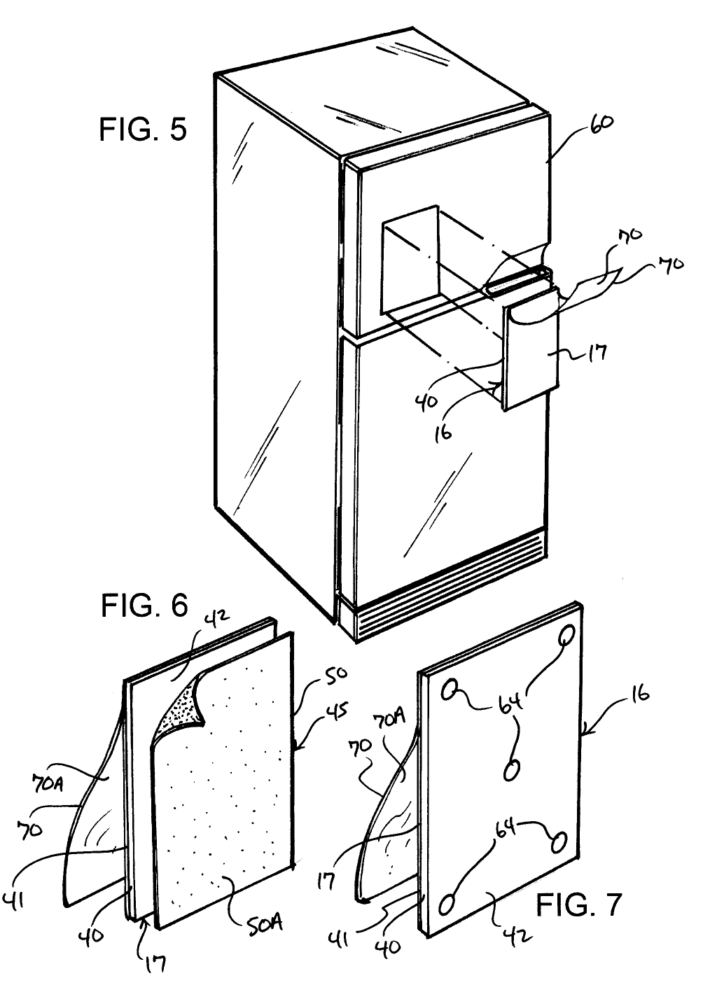

Magnet material 50 and magnet-attracting material 51 form an exemplary, and easy-to-use engagement assembly to detachably secure whiteboard 17 with respect to notebook cover 36. Because engagement element 45 is preferably magnet material 50, sheet 40 carrying whiteboard 17 can be readily removed from notebook cover 36 and magnet material 50 applied to other magnet-attracting surfaces, such as a magnet attracting surface of a wall, post, magnetic chalkboard, refrigerator 60 as illustrated in FIG. 5, and which allows whiteboard 17 to magnetically attached at other selected locations and used in its normal and customary manner to accept and display writing applied thereto from a non-permanent marker apart from notebook cover 36 when so desired. When use of whiteboard 17 is again desired in conjunction with notebook cover 36, sheet 40 forming base 16 and which carries whiteboard 17 need only be removed from the given location, and reinstalled with respect to notebook cover 36 by re-engaging magnet material 50 forming engagement element 45 to magnet-attracting material 51 forming complemental engagement element 46.

Although magnet material 50 forming engagement element 45 is carried by sheet 40 of base 16 and magnet-attracting material 51 is carried by notebook cover 36, this arrangement can be reversed if so desired. To use whiteboard 17 apart from notebook cover 36 in this embodiment, the magnet-attracting material 51 form with sheet 40 need only be used in conjunction with a corresponding magnet material to secure whiteboard 17 in place at a selected location apart from notebook cover 36. Furthermore, although magnet material 50 is a magnet sheet 50A and magnet-attracting material 51 is a corresponding magnet-attracting sheet 51A of ferrous metal as herein disclosed, magnet material 50 may be provided in the form of an applied plurality of discrete magnets 64 as illustrated in FIG. 7, and magnet attracting material 51 may also be in the form of an applied plurality magnet attracting elements. In other embodiments, other forms of engagement and complemental engagement elements may be used to form engagement element 50 and complemental engagement element 51, such as corresponding hook-and-loop features of a hook-and-loop fastener, corresponding snap-engagement fasteners, etc. Also, it is to be understood that the term “element” in conjunction with engagement element 50 and complemental engagement element 51 is not to be interpreted as meaning a single object or thing, but may be interpreted to denote a plurality of objects or things that function to provide the detachable engagement of whiteboard 17 with respect to notebook cover 36 as herein described.

Looking back to FIG. 1, a whiteboard cover 70 is mounted to sheet 40 forming base 16. Whiteboard cover 60 is affixed adjacent to one edge of sheet 40 forming base 16 with glue, lamination, stitching, or the like, and is movable between a first position away from whiteboard 17 as in FIG. 1 to allow writing to be applied to whiteboard 17 with a non-permanent marker in the normal manner, and a second position as substantially illustrated in FIG. 4 across whiteboard 17 overlying and protecting whiteboard 17 to prevent writing applied to whiteboard 17 from smearing or from becoming inadvertently erased. Whiteboard cover 70 is substantially coextensive with respect to whiteboard 17, and is preferably a sheet 70A of thin, flexible material, such as thin, flexible plastic. Sheet 70A of thin, flexible material is preferably transparent to permit any writing applied to whiteboard 17 to be seen therethrough in the second position of whiteboard cover 70 overlying and protecting whiteboard 17.

Those having ordinary skill in the art will readily appreciate that an exemplary notebook 10 is disclosed incorporating a detachable whiteboard 17 in conjunction with notebook cover 36. In the preferred embodiment disclosed herein, the detachable engagement of whiteboard 17 with respect to notebook 10 is disclosed in conjunction with inner face 30A of cover 13 of notebook cover 36 of notebook 10. In other embodiments, the detachable engagement of whiteboard 17 with respect to notebook 10 may be formed at other locations. For example, the detachable engagement of whiteboard 17 with respect to notebook 10 may be similarly formed between inner face 31A of cover 14 of notebook cover 36, outer face 30B of cover 13 of notebook cover 36, outer face 31B of cover 14 of notebook cover 36, etc.

Whiteboard 17 is designed to take on writing/markings from non-permanent markers or whiteboard markers. As such, notebook cover 36 may be formed with one or more removably held whiteboard markers, and/or one or more removably held whiteboard erasers to allow immediate and convenient access to such implements for use in conjunction with whiteboard 17 when desired. As an example of this aspect, in FIG. 1 sleeves 80 and 81 are formed in notebook cover 36 within which are held a whiteboard marker 82 and a whiteboard eraser 83, respectively. Whiteboard marker 82 and whiteboard eraser 83 are inserted and held in their respectively sleeves 80 and 81, can easily be moved from their respective sleeves 80 and 81 and used to apply and erase markings relative to whiteboard 17, and may be reinstalled in their respective sleeves 80 and 81 for storage. More sleeves or pockets or the like may be formed in notebook cover 36 to accommodate any desired number of whiteboard markers and/or whiteboard erasers. In the present embodiment, an inner face 18A of spine 11 is formed with sleeves 80 and 81. Sleeves 80 and 81 can be formed elsewhere along notebook cover 36 as may be desired. Also, hook-and-loop fasteners, clips, or the like may be used between whiteboard marker 82 and whiteboard eraser 83 to removably hold them in place with respect to notebook cover 36 if so desired.

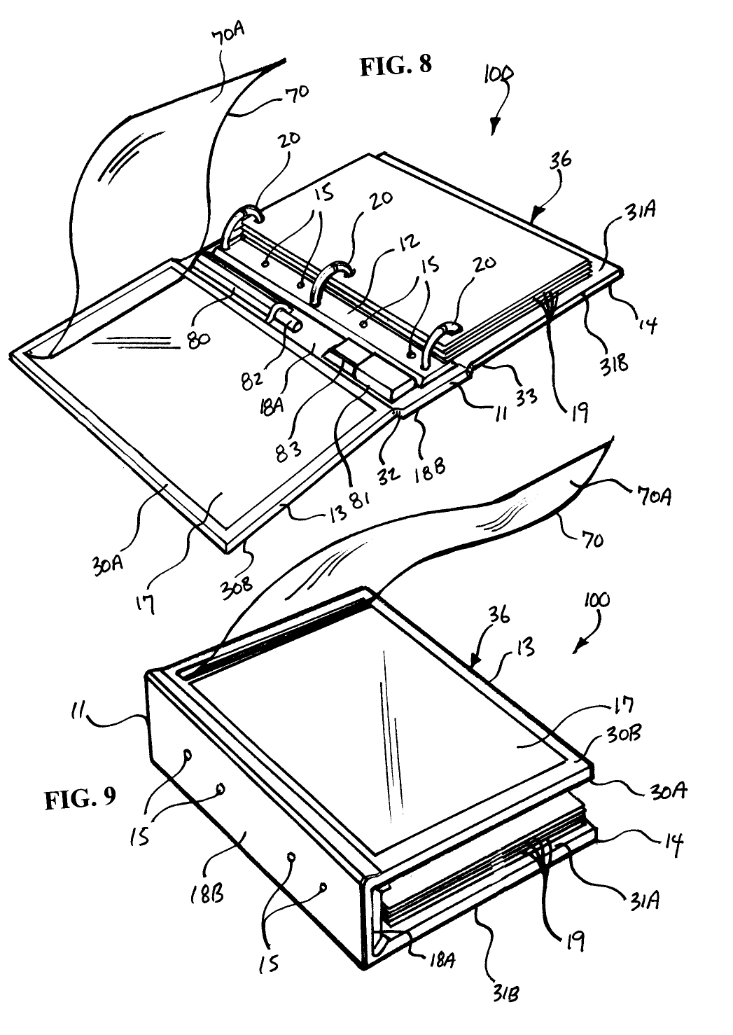

Reference is now made in relevant part to FIGS. 8 and 9, in which there is seen an alternate embodiment of a notebook 100 constructed and arranged in accordance with the principle of the invention. In common with notebook 10, notebook 100 is of or for sheet material, such as paper, notes, preprinted sheets or forms, and the like, and shares notebook cover 36 including spine 11 and covers 13 and 14, binder 12, spine 11 coupled between opposed covers 13 and 14, opposed inner and outer faces 18A and 18B of spine 11, fasteners 15 securing binder 12 to spine 11, sheets 19 retained by claps 20 of binder 12, opposed inner and outer faces 30A and 30B of cover 13, opposed inner and outer faces 31A and 31B of cover 14, covers 13 and 14 secured to either side of spine 11 and together movable at spine 11 between an open position illustrated in FIG. 8 defining an open position of notebook cover 36 and notebook 100 and a closed position illustrated in FIG. 9 illustrating a closed position of notebook cover 36 and notebook 100, hinge 32 formed between cover 13 and one side of spine 11, and hinge 33 formed between cover 14 and the opposing side of spine 11. In common with notebook 10, notebook 100 also shares sleeves 80 and 81 formed in inner face 18A of spine 11 holding whiteboard marker 82 and a whiteboard eraser 83, respectively.

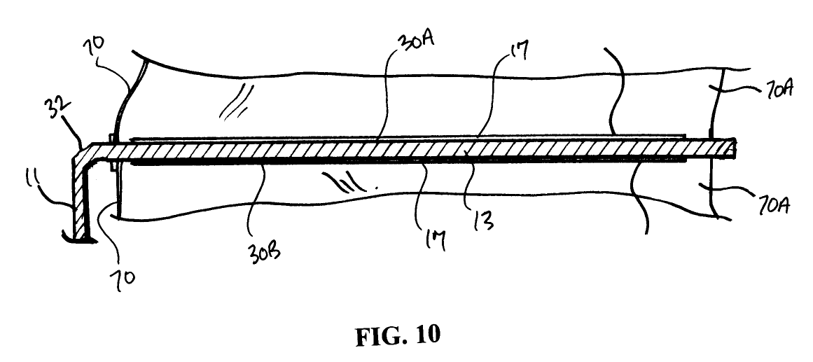

In notebook 10, whiteboard 17 is detachably engaged to notebook cover 36 allowing it to be easily attached and detached with respect to notebook cover 36. In notebook 100 there is a whiteboard 17 and sheet 70A forming whiteboard cover 70 formed with respect to inner face 30A of cover 13 as illustrated in FIGS. 8 and 10, and there is a whiteboard 17 and sheet 70A forming whiteboard cover 70A formed with respect to outer face 30B of cover 13 as illustrated in FIGS. 9 and 10. The structure and function of whiteboards 17 and their respective whiteboard covers 70 are the same as whiteboard 17 and whiteboard cover 70 discussed in notebook 10 discussed in conjunction with FIGS. 1-7. With respect to inner face 30A of cover 13 in the present embodiment denoted at 100, however, whiteboard 17 and sheet 70A forming whiteboard cover 70 are each affixed to inner face 30A of cover 13, and with respect to inner face 30A of cover 13 in the present embodiment denoted at 100 whiteboard 17 and sheet 70A forming whiteboard cover 70 are each affixed to inner face 30A of cover 13. Whiteboards 17, and the respective whiteboard covers 70, are affixed to inner and outer faces 30A and 30B, respectively, of cover 13, by coating, with glue, lamination, heat bonding, rivets or other selected fasteners, or the like forming a secure affixation. Whiteboards 17 can also be sprayed onto their respective surfaces, or applied in other ways so as to form a fixed bonding to their respective surfaces.

In notebook 100 there is a whiteboard and associated whiteboard cover associated each of the inner and outer faces 30A and 30B of cover 13. If desired, only one of inner and outer faces 30A and 30B may be provided with a whiteboard and associated whiteboard cover 70. If desired, either or both of inner and outer faces 31A and 31B of cover 14 may be furnished with an affixed whiteboard and associated whiteboard cover. A whiteboard and associated whiteboard cover may also be affixed to inner 18A of spine 11, and/or to outer face 18B of spine 11.

The invention has been described above with reference to preferred embodiments. However, those skilled in the art will recognize that changes and modifications may be made to the embodiments without departing from the nature and scope of the invention. For instance, notebook 10 can be configured for any desired use, such as a school notebook, a reminder book, a planner, an address book, etc., and may be constructed of any desired size to meet any specific need. Also, binder 12 is exemplary of a clamp binder, and other suitable binder forms may be used without departing from the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A notebook, comprising:
a notebook of or for sheet material;
a whiteboard formed in a base;
an engagement element formed in the base; and
a detachably engagable complemental engagement element formed in the notebook to detachably secure the base, and the whiteboard carried by the base, to the notebook leaving the whiteboard available for use in accepting writing from a whiteboard marker.

2. The notebook according to claim 1, wherein the engagement element is one of magnet material and magnet-attracting material, and the complemental engagement element is the other of the magnet material and the magnet-attracting material.

3. The notebook according to claim 1, further comprising a whiteboard cover mounted to the base for movement between a first position away from the whiteboard and a second position overlying and protecting the whiteboard.

4. The notebook according to claim 3, wherein the whiteboard cover comprises a sheet of thin, flexible material.

5. The notebook according to claim 4, wherein the sheet of thin, flexible material is transparent.

6. A notebook, comprising:
a binder, to receive and retain sheets of paper, formed in a notebook cover;
a sheet of substantially rigid material having opposed upper and lower faces;
the upper face of the sheet of substantially rigid material formed with a whiteboard;
the lower face of the sheet of substantially rigid material formed with an engagement element; and
the notebook cover formed with a detachably engagable complemental engagement element.

7. The notebook according to claim 6, wherein the engagement element is one of magnet material and magnet-attracting material, and the complemental engagement element is the other of the magnet material and the magnet-attracting material.

8. The notebook according to claim 6, further comprising a whiteboard cover mounted to the sheet of substantially rigid material for movement between a first position away from the whiteboard and a second position overlying and protecting the whiteboard.

9. The notebook according to claim 8, wherein the whiteboard cover comprises a sheet of thin, flexible material.

10. The notebook according to claim 9, wherein the sheet of thin, flexible material is transparent.

11. The notebook according to claim 6, further comprising at least one whiteboard marker removably held by the notebook cover.

12. The notebook according to claim 11, further comprising at least one whiteboard eraser removably held by the notebook cover.

13. A notebook, comprising:
a spine, formed with a binder to receive and retain sheets of paper, coupled between opposed first and second covers, the first and second covers together movable at the spine between open and closed positions with respect to the binder formed in the spine;
a sheet of substantially rigid material having opposed upper and lower faces;
the upper face of the sheet of substantially rigid material formed with a whiteboard;
the lower face of the sheet of substantially rigid material formed with an engagement element; and
the first cover formed with a detachably engagable complemental engagement element.

14. The notebook according to claim 13, wherein the engagement element is one of magnet material and magnet-attracting material, and the complemental engagement element is the other of the magnet material and the magnet-attracting material.

15. The notebook according to claim 13, further comprising a whiteboard cover mounted to the sheet of substantially rigid material for movement between a first position away from the whiteboard and a second position overlying and protecting the whiteboard.

16. The notebook according to claim 15, wherein the whiteboard cover comprises a sheet of thin, flexible material.

17. The notebook according to claim 16, wherein the sheet of thin, flexible material is transparent.

18. The notebook according to claim 13, further comprising the spine and the first and second covers together forming a notebook cover of the notebook, at least one whiteboard marker removably held by the notebook cover, and at least one whiteboard eraser removably held by the notebook cover.

19. A notebook, comprising:
a spine, formed with a binder to receive and retain sheets of paper, coupled between opposed first and second covers;
the first cover having a first inner face;
the second cover having a second inner face;
a sheet of substantially rigid material having opposed upper and lower faces;
the upper face of the sheet of substantially rigid material formed with a whiteboard;
the lower face of the sheet of substantially rigid material formed with an engagement element;
the first inner face of the first cover formed with a detachably engagable complemental engagement element;
the engagement element detachably engaged to the complemental engagement element detachably engaging the sheet of substantially rigid material to the first inner face of the front cover leaving the whiteboard available to receive writing thereon; and
the first and second covers together movable at the spine between an open position exposing the binder, the whiteboard, and the second inner face of the second cover, and a closed position bringing the first inner face of the first cover in juxtaposition with respect to the second inner face of the second cover to substantially enclose the whiteboard and the binder between the first and second inner faces of the first and second covers, respectively.

20. The notebook according to claim 19, wherein the engagement element is one of magnet material and magnet-attracting material, and the complemental engagement element is the other of the magnet material and the magnet-attracting material.

21. The notebook according to claim 19, further comprising a whiteboard cover mounted to the sheet of substantially rigid material for movement between a first position away from the whiteboard and a second position overlying and protecting the whiteboard.

22. The notebook according to claim 21, wherein the whiteboard cover comprises a sheet of thin, flexible material.

23. The notebook according to claim 22, wherein the sheet of thin, flexible material is transparent.

24. The notebook according to claim 19, further comprising the spine and the first and second covers together forming a notebook cover of the notebook, at least one whiteboard marker removably held by the notebook cover, and at least one whiteboard eraser removably held by the notebook cover.

25. A notebook, comprising:
a notebook of or for sheet material; and
a whiteboard formed in the notebook.

26. The notebook according to claim 25, further comprising a whiteboard cover mounted to notebook for movement between a first position away from the whiteboard and a second position overlying and protecting the whiteboard.

27. The notebook according to claim 26, wherein the whiteboard cover comprises a sheet of thin, flexible material.

28. The notebook according to claim 27, wherein the sheet of thin, flexible material is transparent.

29. The notebook according to claim 28, wherein the whiteboard and the whiteboard cover are affixed to an inner face of the notebook.

30. The notebook according to claim 28, wherein the whiteboard and the whiteboard cover are affixed to an outer face of the notebook.
